(19) United States
(12) Patent Application Publication
(10) Pub. No.: US 2024/0166839 A1
(43) Pub. Date: May 23, 2024

(54) Fiber Reinforced Thermoplastic Polymer Composition Containing Flame Retardant Package

(71) Applicant: Celanese International Corporation, Irving, TX (US)

(72) Inventors: David W. Eastep, Winona, MN (US); Aaron H. Johnson, Winona, MN (US)

(21) Appl. No.: 18/494,139

(22) Filed: Oct. 25, 2023

Related U.S. Application Data
(60) Provisional application No. 63/419,595, filed on Oct. 26, 2022.
(60) Provisional application No. 63/450,512, filed on Mar. 7, 2023.
(60) Provisional application No. 63/504,893, filed on May 30, 2023.

(51) Int. Cl. C08K 3/016; C08K 3/32; C08K 3/38; C08K 5/098; C08K 5/5313; C08K 5/5317; C08K 7/02

(52) U.S. Cl. CPC C08K 3/016; C08K 3/32; C08K 3/38; C08K 5/098; C08K 5/5313; C08K 5/5317; C08K 7/02; C08K 2003/329; C08K 2003/387; C08K 2201/014; C08K 2201/016

(57) ABSTRACT

A long fiber-reinforced polymer composition is disclosed having excellent flame retardant properties. The flame retardant composition can include a flame retardant system comprised of a metal phosphinate in combination with elevated levels of a synergist, such as a polyphosphate. The composition can display excellent flame resistant properties at extremely small thicknesses.

### RELATED APPLICATIONS

The present application is based upon and claims priority to U.S. Provisional Patent Application Ser. No. 63/419,595, having a filing date of Oct. 26, 2022; U.S. Provisional Patent Application Ser. No. 63/450,512, having a filing date of Mar. 7, 2023; and U.S. Provisional Patent Application Ser. No. 63/504,893, having a filing date of May 30, 2023, all of which are incorporated herein by reference.

### BACKGROUND

Long fiber-reinforced polymer compositions are often employed in molded parts to provide improved mechanical properties. Typically, such compositions are formed by a process that involves extruding a polymer through an impregnation die and onto a plurality of continuous lengths of reinforcing fibers. The polymer and reinforcing fibers are pulled through the die to cause thorough impregnation of individual fiber strands with the resin.

Molded articles formed from long fiber-reinforced polymer compositions can offer various advantages and benefits. For instance, the compositions are not only well suited to producing articles having all different types of shape, but are also well suited to producing articles having excellent mechanical properties, including tensile strength. Consequently, long fiber-reinforced polymer compositions are well suited for use in emerging markets. For instance, the reinforced polymer compositions are well suited for producing electrical components and housings designed for use in electric vehicles. In addition, the reinforced polymer compositions are well suited for producing electronic modules, particularly housings for printed circuit boards, antennae elements, radio frequency devices, sensors, transmitting elements, cameras, global positioning devices, and the like that may be used in LTE or 5G systems.

One problem faced by those skilled in the art in producing long fiber-reinforced articles is making the products flame resistant. Although almost a limitless variety of different flame retardants are marketed and sold commercially, selecting an appropriate flame retardant for a particular fiber-reinforced product is difficult and unpredictable. Further, many available flame retardants contain halogen compounds, such as bromine compounds, which can produce harsh chemical gases during production. Antimony trioxide is also used as a synergist with halogenated systems. This compound can contain levels of arsenic and lead. In view of the above, a need exists for a flame retardant composition that is compatible with a fiber-reinforced polymer product, and particularly a long fiber-reinforced polymer product. A need also exists for a flame retardant composition for incorporation into a fiber-reinforced polymer product that is halogen-free.

### SUMMARY

In general, the present disclosure is directed to long fiber-reinforced polymer compositions that contain a flame retardant system that exhibits excellent flame resistance even at small thicknesses.

In accordance with one embodiment of the present invention, a fiber-reinforced polymer composition is disclosed that comprises from about 30 wt. % to about 90 wt. % of a polymer matrix that contains at least one thermoplastic polymer and from about 10 wt. % to about 70 wt. % of a plurality of long reinforcing fibers that are distributed within the polymer matrix. Although various different thermoplastic polymers can be incorporated into the composition, in one embodiment, the polymer matrix is comprised primarily of a polyamide polymer. The polyamide polymer may comprise nylon-6, nylon-6,6, and mixtures thereof. In one aspect, the polymer composition contains a mixture of nylon-6 and nylon-6,6 at a weight ratio of from about 1:2 to about 1:8, such as from about 1:3 to about 1:5. The polyamide polymer may also comprise a semi-aromatic polyamide or a wholly aromatic polyamide.

The fiber-reinforced polymer composition further contains a flame retardant system. The flame retardant system includes a metal phosphinate and a synergist. In accordance with the present disclosure, the synergist can be present in relatively great amounts in relationship to the metal phosphinate. For instance, the synergist may comprise a polyphosphate, such as a melamine polyphosphate. The metal phosphinate can be present in relation to the synergist at a weight ratio of from about 0.8:1 to about 1:3, such as from about 1:1 to about 1:2, such as from about 1:1.1 to about 1:1.5. In one embodiment, the polymer composition may contain a first synergist and a second synergist. The first synergist and the second synergist may be the same or different. The first synergist can be combined and compounded with the metal phosphinate and added to the polymer composition. The second synergist, on the other hand, can be compounded with a thermoplastic polymer, such as a polyamide polymer, and added to the composition. It was discovered that increasing the amount of the synergist can dramatically improve the flame retardant properties of the polymer composition, especially in long fiber-reinforced polymer applications, while preserving fiber length during melt processing.

In one aspect, the synergist, such as melamine polyphosphate can be present in the polymer composition in an amount greater than about 5% by weight, such as in an amount greater than about 6% by weight, such as in an amount greater than about 7% by weight, and generally in an amount less than about 20% by weight, such as in an amount less than about 15% by weight, such as in an amount less than about 12% by weight, such as in an amount less than about 10% by weight. The metal phosphinate, on the other hand, can be present in the polymer composition in an amount greater than about 4% by weight, such as in an amount greater than about 5% by weight, such as in an amount greater than about 6% by weight, and generally in an amount less than about 15% by weight, such as in an amount less than about 12% by weight, such as in an amount less than about 10% by weight, such as in an amount less than about 8% by weight.

In one aspect, the flame retardant system may further include an inorganic compound, such as zinc borate. The inorganic compound can be present in relatively minor amounts, such as in amounts less than about 2% by weight, such as in amounts less than about 1% by weight, and generally in an amount greater than about 0.1% by weight, such as in an amount greater than about 0.2% by weight.

The polymer composition can be formulated to exhibit a VO rating as determined in accordance with UL 94 at a thickness of only 1.6 mm. In addition, the polymer composition can be formulated to display a comparative tracking index of 600 volts or more as determined in accordance with IC 60112:2020.

In one embodiment, the metal phosphinate has the general formula (I) and/or formula (II):

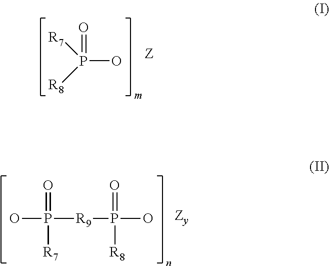

wherein, R₇ and R₈ are, independently, hydrogen or substituted or unsubstituted, straight chain, branched, or cyclic hydrocarbon groups having 1 to 6 carbon atoms; R₉ is a substituted or unsubstituted, straight chain, branched, or cyclic C₁-C₁₀ alkylene, arylene, arylalkylene, or alkylarylene group; Z is Mg, Ca, Al, Sb, Sn, Ge, Ti, Zn, Fe, Zr, Ce, Bi, Sr, Mn, Li, Na, K, and/or a protonated nitrogen base; y is from 1 to 4; n is from 1 to 4; and m is from 1 to 4.

In another aspect of the present disclosure, the fiber-reinforced polymer composition contains a flame retardant system that comprises a metal phosphinate in combination with a synergist as described above. In this embodiment, however, the synergist comprises a metal salt of a phosphonic acid, a phosphonic acid, or a mixture of both. For example, in one aspect, the synergist comprises a mixture of an aluminum salt of a phosphonic acid and a phosphonic acid.

The synergist can be present in the composition in an amount greater than about 2% by weight and in an amount less than about 5% by weight. In one aspect, the polymer composition contains a phosphonic acid in an amount from about 1.2% by weight to about 2.8% by weight and a metal salt of a phosphonic acid, such as an aluminum salt of a phosphonic acid, in an amount from about 0.8% by weight to about 1.8% by weight. The metal phosphinate can comprise aluminum diethyl phosphinate and can be present in the polymer composition in an amount greater than about 8% by weight, such as in an amount greater than about 10% by weight, such as in an amount greater than about 11% by weight, and in an amount less than about 18% by weight, such as in an amount less than about 16% by weight, such as in an amount less than about 14% by weight. The polymer composition can also contain a metal salt of a carboxylic acid, such as calcium stearate and/or aluminum distearate, and/or one or more metal iodide compounds, such as potassium iodide and/or copper iodide. The metal salt of the carboxylic acid can be present in the composition in an amount greater than about 0.2% by weight, and in an amount less than about 3% by weight. The one or more metal iodides can be present in the composition in an amount of less than about 0.5% by weight, such as in an amount less than about 0.3% by weight and in an amount greater than about 0.0001% by weight.

All different types of polymer articles can be molded from the polymer composition of the present disclosure. In one embodiment, a composite tape can be formed from the fiber-reinforced polymer composition. The tape can include a plurality of long reinforcing fibers that are continuous and unidirectionally oriented with in the polymer matrix. The fibers can be present in the tape in an amount of from about 50% to about 70% by weight. In one aspect, the tape can be over molded with a fiber-containing composition.

The polymer composition is particularly well suited to being molded into a component of an electrical device. The electrical device, for instance, can include an electrically conductive component surrounded by a molded polymer component formed from the polymer composition of the present disclosure.

In one embodiment, the electrical device can be an electrical connector that comprises opposing walls between which a passageway is defined for receiving a contact pin. At least one of the walls can be made from the flame retardant polymer composition as described above. In one particular embodiment, the electrical connector can comprise a high voltage powertrain or charging connector or housing for an electric vehicle.

In one aspect, the fiber-reinforced polymer composition of the present disclosure can be used to produce a housing for an electronic module. The housing can be configured to receive at least one electronic component. The electronic component can comprise an antennae element configured to transmit and receive 5G radio frequency signals. The electronic component can also alternatively include a fiber optic assembly for receiving and transmitting light pulses. In still another aspect, the electronic component can include a camera. In still another embodiment, the polymer composition comprises a structural component of a battery, such as a side support, a cover, a separator, or a bottom support.

Polymer compositions made according to the present disclosure may display excellent mechanical properties. For instance, the polymer composition can display a tensile modulus of greater than about 8,000 MPa, such as greater than about 9,000 MPa, such as greater than about 10,000 MPa. In one embodiment, the tensile modulus can be greater than about 12,000 MPa, such as greater than about 13,000 MPa, and generally less than about 20,000 MPa.

The polymer composition can also display a flexural modulus of greater than about 7,000 MPa, such as greater than about 8,000 MPa, such as greater than about 9,000 MPa, such as greater than about 9,500 MPa. In one embodiment, the flexural modulus can be greater than about 11,000 MPa, such as greater than about 12,000 MPa, and generally less than about 20,000 MPa.

Even at the above modulus levels, the polymer composition can display excellent impact strength. For instance, the polymer composition can have a Charpy notched impact strength at 23° C. of greater than about 20 kJ/m², such as greater than about 21 kJ/m², such as greater than about 22 kJ/m², such as greater than about 23 kJ/m², such as greater than about 24 kJ/m², such as greater than about 25 kJ/m², such as greater than about 26 kJ/m², and less than about 35 kJ/m².

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic illustration of one embodiment of a system that may be used to form the polymer composition of the present invention;

FIG. 2 is a cross-sectional view of an impregnation die that may be employed in the system shown in FIG. 1;

FIG. 3 is an exploded perspective view of one embodiment of an electronic module that may employ the polymer composition of the present invention;

FIG. 4 depicts one embodiment of a 5G system that may employ an electronic module as shown in FIG. 3;

FIG. 5 is a perspective view of one embodiment of a housing for an electrical device made in accordance with the present disclosure, such as the housing of a circuit breaker;

FIG. 6 is a perspective view of a high voltage electrical connector that includes a polymer component made in accordance with the present disclosure;

FIG. 7 is a perspective view of a molded electrical housing made in accordance with the present disclosure, which may be used to enclose a lithium ion battery;

FIG. 8 is a perspective view of a battery plug board that may be made in accordance with the present disclosure;

FIG. 9 is a perspective view of a circuit breaker that may be made in accordance with the present disclosure;

FIG. 10 is a perspective view of a contact rail that includes a polymer component made in accordance with the present disclosure;

FIG. 11 is a perspective view of an electrical switch that may be made in accordance with the present disclosure;

FIG. 12 is a perspective view of an electrical connector that may be made in accordance with the present disclosure; and

FIG. 13 is a perspective assembly view of one embodiment of a power distribution box that may employ the polymer composition of the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present invention.

Generally speaking, the present disclosure is directed to a fiber-reinforced polymer composition for use in a variety of different applications including use in electronic devices and systems. The composition comprises a polymer matrix that contains a thermoplastic polymer and a plurality of long reinforcing fibers that are distributed within the polymer matrix. Through careful selection of the particular nature and concentration of the components of the polymer composition, the present inventors have discovered that the resulting composition can exhibit a synergistic combination of excellent flame retardant properties, excellent mechanical properties including high strength, and can even include good electrical properties (i.e., low dielectric constant and dissipation factor).

In one aspect, the present disclosure is directed to a flame retardant polymer composition that contains at least one thermoplastic resin in combination with a flame retardant system. The flame retardant system can include a combination of a metal phosphinate and a synergist. The synergist can be, for instance, a polyphosphate, particularly a nitrogen-containing polyphosphate. In accordance with the present disclosure, relatively great amounts of the synergist are added to the composition in relation to the metal phosphinate. In fact, in one aspect, a first synergist can be added precompounded with the metal phosphinate and a second synergist can be added compounded with a thermoplastic polymer, such as a polyamide polymer. The first synergist and the second synergist can be the same or different and both can comprise polyphosphates. Adding greater amounts of the synergist to the composition has been found to dramatically improve the overall fire resistant properties of the polymer composition and of articles made from the composition. Adding a first synergist and a second synergist as described above has also been found to preserve glass fiber lengths during processing. It is also believed that adding the second synergist with the polymer carrier leads to better dispersion of the synergist within the thermoplastic matrix.

As described above, the combination of the metal phosphinate and the synergist(s) has been found to dramatically improve the flame resistant properties of the polymer composition at extremely small thicknesses. For example, the polymer composition of the present disclosure can be formulated so as to exhibit a V0 rating as determined in accordance with UL 94 at a thickness of only 1.6 mm, such as only 0.8 mm, such as only 0.4 mm. In addition, it was discovered that not only does the flame retardant system of the present disclosure not interfere with the melt processing characteristics of the polymer composition, but actually has been found to produce a polymer composition with excellent fiber length retention.

The degree to which the composition can extinguish a fire (“char formation”) may be represented by its Limiting Oxygen Index (“LOI”), which is the volume percentage of oxygen needed to support combustion. More particularly, the LOI of the polymer composition may be about 25 or more, in some embodiments about 27 or more, in some embodiments about 28 or more, such as greater than about 30, such as greater than about 32, such as greater than about 34, such as greater than about 36, such as greater than about 38, and in some embodiments, from about 40 to 100, as determined in accordance with ISO 4589:2017 (technically equivalent to ASTM D2863-19).

In addition to flame retardant properties and/or heat aging stability, the polymer composition of the present disclosure can also display excellent comparative tracking index properties. The comparative tracking index (CTI) is the maximum voltage, measured in volts, at which a material withstands 50 drops of contaminated water without tracking. Tracking is defined as the formation of conductive paths due to electrical stress, humidity, and contamination. The comparative tracking index test is an accelerated simulation to determine possible future failures that typically result in a short in electrical equipment using the polyamide polymer composition as an insulating material. Comparative tracking index can be measured according to Test IEC 60112:2020. The flame retardant polyamide polymer composition of the present disclosure can be formulated to display a comparative tracking index of 600 volts or more, such as 650 volts or more, such as 700 volts or more (and less than about 1000 volts).

The polymer composition of the present disclosure can also display excellent mechanical properties, particularly increased impact strength in combination with high stiffness. For example, the polymer composition can display a tensile modulus of greater than about 8,000 MPa, such as greater than about 9,000 MPa, such as greater than about 10,000 MPs, such as greater than about 11,000 MPa, such as greater than about 12,000 MPa, such as greater than about 13,000 MPa, and generally less than about 20,000 MPa. The composition can display a flexural modulus at 23° C. of greater than about 7,000 MPa, such as greater than about 8,000 MPa, such as greater than about 9,000 MPa, such as greater than about 10,000 MPa, such as greater than about 11,000 MPa, such as greater than about 12,000 MPa, and generally less than about 23,000 MPa.

The polymer composition can display a Charpy notched impact strength at 23° C. of greater than about 20 kJ/m², such as greater than about 21 kJ/m², such as greater than about 22 kJ/m², such as greater than about 23 kJ/m², such as greater than about 24 kJ/m², such as greater than about 25 kJ/m², such as greater than about 26 kJ/m², and generally less than about 40 kJ/m².

The polymer composition can display a tensile stress at break of greater than about 130 MPa, such as greater than about 140 MPa, such as greater than about 150 MPa, such as greater than about 160 MPa, and generally less than about 200 MPa. The polymer composition can display a tensile strain at break of greater than about 1%, such as greater than about 1.2%, such as greater than about 1.3%, and generally less than about 2.5%, such as less than about 2%, such as less than about 1.9%. The polymer composition can display a flexural strength at 23° C. of greater than about 220 MPa, such as greater than about 225 MPa, such as greater than about 230 MPa, such as greater than about 235 MPa, such as greater than about 240 MPa, such as greater than about 250 MPa, such as greater than about 255 MPa, and generally less than about 320 MPa.

Due to the excellent flame resistance properties and excellent mechanical properties, the polymer composition of the present disclosure is well suited for making all different types of articles and components.

In one embodiment, a composite tape can be formed from the fiber-reinforced polymer composition. The tape can include a plurality of long reinforcing fibers that are continuous and unidirectionally oriented with in the polymer matrix. The fibers can be present in the tape in an amount of from about 50% to about 70% by weight. In one aspect, the tape can be over molded with a fiber-containing composition. Alternatively, the composition can be in the form of pellets that can be fed to molding processes for producing articles.

The polymer composition is particularly well suited for producing all different types of electrical components. Such articles can include high voltage powertrain components and other devices that may be powered using lithium ion batteries. The polymer composition can serve as a housing for encasing the electrical component or can be an insulative component that directly surrounds an electrical contact pin or other conductive member. The long fiber-reinforced polymer composition of the present disclosure can also be formulated with good electrical properties making the composition also well suited for producing a housing for an electronic module that receives one or more electronic components, such as a printed circuit board, antennae elements, radio frequency sensing elements, sensors, transmitting elements, cameras, global positioning devices, and the like. In still another embodiment, the polymer composition is used to produce a structural component of a battery, such as a side support, a cover, a separator, or a bottom support.

In addition to the above, the long fiber-reinforced polymer composition of the present disclosure can also be used in numerous other applications. For example, the polymer composition provides light weighting, better dimensional control, thinner walls, higher impact, higher temperature performance, and better creep and fatigue than many other similar compositions.

Various embodiments of the present invention will now be described in more detail.

### I. Polymer Matrix

### A. Thermoplastic Polymer

The polymer matrix functions as a continuous phase of the composition and contains one or more thermoplastic polymers. Thermoplastic polymers well suited for use in the composition include polyamide polymers, polyarylene sulfide polymers, polyaryletherketone polymers, polyimide polymers, and mixtures thereof. The one or more thermoplastic polymers can be present in the polymer matrix in an amount from about 40% by weight to about 90% by weight, including all increments of 1% by weight therebetween. For example, one or more thermoplastic polymers can be contained in the polymer composition in an amount greater than about 45% by weight, such as in an amount greater than about 50% by weight, such as in an amount greater than about 55% by weight and generally in an amount less than about 85% by weight, such as in an amount less than about 80% by weight, such as in an amount less than about 75% by weight, such as in an amount less than about 70% by weight, such as in an amount less than about 65% by weight, such as in an amount less than about 60% by weight.

The long fiber-reinforced polymer composition of the present disclosure is particularly well suited for use with polyamide polymers.

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-6 to nylon-66 is typically from about 1:2 to about 1:8, such as from about 1:3 to about 1:6, such as from about 1:3 to about 1:5.

In one aspect, for instance, the polymer composition contains a nylon-66 polymer in an amount greater than about 30% by weight, such as in an amount greater than about 35% by weight, such as in an amount greater than about 40% by weight, and in an amount less than about 60% by weight, such as in an amount less than about 55% by weight, such as in an amount less than about 50% by weight, such as in an amount less than about 45% by weight. The nylon-66 polymer can be combined with a nylon-6 polymer. The nylon-6 polymer, in one aspect, can be present in the polymer composition in an amount greater than about 5% by weight, such as in an amount greater than about 8% by weight, and in an amount less than about 20% by weight, such as in an amount less than about 15% by weight, such as in an amount less than about 12% by weight.

It is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

In one embodiment, the polymer composition contains primarily aliphatic polyamide polymers that may be blended with one or more semi-aromatic polyamide polymers or a wholly aromatic polyamide polymer. In other embodiments, the polymer composition may only contain semi-aromatic polyamide polymers, may only contain wholly aromatic polyamide polymers, or may only contain a combination of semi-aromatic polyamide polymers and wholly aromatic polyamide polymers.

The polyamide employed in the polymer composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2013 (glass transition) and 11357-3:2011 (melting).

In one embodiment, the polyamide polymer incorporated into the polymer composition can comprise a post-industrial recycled polymer. For instance, the recycled polyamide polymer can be obtained from industrial fiber including tire cord, from carpet fiber, from textile fiber, from films, from fabrics including airbag fabrics, and the like. When incorporated into the polymer composition, the recycled polyamide polymers are optionally combined with virgin polymers. For example, the weight ratio between recycled polyamide polymers and virgin polyamide polymers can be from about 1:10 to about 10:1. For example, the amount of recycled polyamide polymer incorporated into the polymer composition can be greater than about 8% by weight, such as greater than about 10% by weight, such as greater than about 12% by weight, such as greater than about 15% by weight, such as greater than about 18% by weight, such as greater than about 20% by weight, such as greater than about 22% by weight, such as greater than about 30% by weight, such as greater than about 40% by weight, such as greater than about 50% by weight, such as greater than about 70% by weight, such as greater than about 80% by weight, such as greater than about 90% by weight, such as up to 100% by weight. The recycled polyamide is generally present in an amount less than about 90% by weight, such as in an amount less than about 70% by weight, such as in an amount less than about 50% by weight, such as in an amount less than about 45% by weight, such as less than about 35% by weight, such as less than about 30% by weight, based on the total amount of polyamide polymers present.

### B. Flame Retardant System

In addition to one or more thermoplastic polymers, the polymer matrix may also contain a flame retardant system to help achieve the desired flammability performance. In one aspect, the flame retardant system of the present disclosure only contains two flame retardant components, although in other embodiments various other components may be added. Excellent flame resistant properties in combination with excellent melt processing characteristics can be obtained by incorporating into the polymer composition a non-halogen flame retardant in combination with a synergist.

In one embodiment, the flame retardant system of the present disclosure contains a metal phosphinate in combination with a synergist. In one aspect, the synergist can comprise a polyphosphate and/or a melamine or melamine derivative. The synergist, for instance, can comprise a nitrogen-containing polyphosphate, such as a melamine polyphosphate. In one aspect, the synergist can comprise a metal salt of a phosphonic acid, a phosphonic acid, or mixtures thereof.

The amount of flame retardant system incorporated into the polymer composition can vary depending upon the particular application and the desired result. In general, the flame retardant system is present in the polymer composition in an amount greater than about 10% by weight, such as in an amount greater than about 12% by weight, such as in an amount greater than about 13% by weight, such as in an amount of greater than about 14% by weight, such as in an amount greater than about 15% by weight. The flame retardant system is generally present in the composition in an amount less than about 28% by weight, such as in an amount less than about 22% by weight, such as in an amount less than about 17% by weight.

As described above, the flame retardant system can include a phosphinate flame retardant, such as a metal phosphinate. Such phosphinates are typically salts of a phosphinic acid and/or diphosphinic acid, such as those having the general formula (I) and/or formula (II):

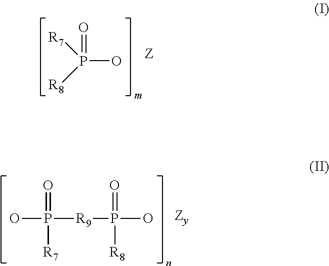

wherein,
R₇ and R₈ are, independently, hydrogen or substituted or unsubstituted, straight chain, branched, or cyclic hydrocarbon groups (e.g., alkyl, alkenyl, alkynyl, aralkyl, aryl, alkaryl, etc.) having 1 to 6 carbon atoms, particularly alkyl groups having 1 to 4 carbon atoms, such as methyl, ethyl, n-propyl, iso-propyl, n-butyl, or tert-butyl groups;
R₉ is a substituted or unsubstituted, straight chain, branched, or cyclic C₁-C₁₀ alkylene, arylene, arylalkylene, or alkylarylene group, such as a methylene, ethylene, n-propylene, iso-propylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, t-butylnaphthylene, phenylethylene, phenylpropylene or phenylbutylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4, and preferably 1 to 2 (e.g., 1);
n is from 1 to 4, and preferably 1 to 2 (e.g. 1); and
m is from 1 to 4 and preferably 1 to 2 (e.g., 2).

The phosphinates may be prepared using any known technique, such as by reacting a phosphinic acid with a metal carbonate, metal hydroxide, or metal oxides in aqueous solution. Particularly suitable phosphinates include, for example, metal salts of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, etc. The resulting salts are typically monomeric compounds; however, polymeric phosphinates may also be formed. Particularly suitable metals for the salts may include Al and Zn. For instance, one particularly suitable phosphinate is zinc diethylphosphinate. Another particularly suitable phosphinate is aluminum diethylphosphinate.

One or more metal phosphinates can generally be present in the polymer composition in an amount greater than about 4% by weight, such as in an amount greater than about 5% by weight, such as in an amount greater than about 6% by weight. One or more metal phosphinates are generally present in the polymer composition in an amount less than about 20% by weight, such as in an amount less than about 12% by weight, such as in an amount less than about 9% by weight.

In accordance with the present disclosure, the metal phosphinate is combined with a synergist. The synergist can comprise a polyphosphate, such as a nitrogen-containing polyphosphate. The polyphosphate may have the following general formula:

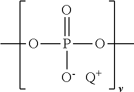

v is from 1 to 1000, in some embodiments from 2 to 500, in some embodiments from 3 to 100, and in some embodiments, from 5 to 50; and Q is a nitrogen base. Suitable nitrogen bases may include those having a substituted or unsubstituted ring structure, along with at least one nitrogen heteroatom in the ring structure (e.g., heterocyclic or heteroaryl group) and/or at least one nitrogen-containing functional group (e.g., amino, acylamino, etc.) substituted at a carbon atom and/or a heteroatom of the ring structure. Examples of such heterocyclic groups may include, for instance, pyrrolidine, imidazoline, pyrazolidine, oxazolidine, isoxazolidine, thiazolidine, isothiazolidine, piperidine, piperazine, thiomorpholine, etc. Likewise, examples of heteroaryl groups may include, for instance, pyrrole, imidazole, pyrazole, oxazole, isoxazole, thiazole, isothiazole, triazole, furazan, oxadiazole, tetrazole, pyridine, diazine, oxazine, triazine, tetrazine, and so forth. If desired, the ring structure of the base may also be substituted with one or more functional groups, such as acyl, acyloxy, acylamino, alkoxy, alkenyl, alkyl, amino, aryl, aryloxy, carboxyl, carboxyl ester, cycloalkyl, hydroxyl, halo, haloalkyl, heteroaryl, heterocyclyl, etc. Substitution may occur at a heteroatom and/or a carbon atom of the ring structure. For instance, one suitable nitrogen base may be a triazine in which one or more of the carbon atoms in the ring structure are substituted by an amino group. One particularly suitable base is melamine, which contains three carbon atoms in the ring structure substituted with an amino functional group. Such bases may form a melamine polyphosphate.

The polyphosphate synergist can generally be present in the polymer composition in an amount greater than about 4% by weight, such as in an amount greater than about 5% by weight, such as in an amount greater than about 6% by weight, such as in an amount greater than about 7% by weight, and generally less than about 20% by weight, such as in an amount less than about 12% by weight, such as in an amount less than about 10% by weight.

In accordance with the present disclosure, relatively great amounts of synergists can be present in the polymer composition in relation to the metal phosphinate. For instance, the metal phosphinate can be present in the polymer composition in relation to the synergist at a weight ratio of from about 0.8:1 to about 1:3, such as from about 1:1 to about 1:2, such as from about 1:1.1 to about 1:1.5. In one aspect, the synergist is present in the polymer composition in an amount greater than a metal phosphinate.

In one aspect, the polymer composition can contain a first synergist and a second synergist. The first synergist can be the same or can be different than the second synergist. The first synergist can be compounded with the metal phosphinate and then combined with the thermoplastic polymer and long reinforcing fibers in producing a melt blended composition. The second synergist, on the other hand, can be combined with a carrier polymer and then melt blended with the other components. The carrier polymer can, in one aspect, be the same type of polymer used to form the matrix of the polymer composition. For instance, if the primary matrix polymer of the polymer composition is a polyamide, the carrier polymer can also be a polyamide, such as nylon-6 or nylon-6,6. The second synergist can be combined with the carrier polymer such that the second synergist comprises from about 50% to about 70% by weight of the compounded component, while the carrier polymer comprises from about 30% to about 50% by weight of the compounded component.

As stated above, the first synergist can be the same as the second synergist. For instance, the first and second synergists can both comprise a melamine polyphosphate.

It is believed that there are various advantages and benefits to adding the first synergist precompounded with the metal phosphinate and adding the second synergist compounded with a carrier polymer in producing a melt blended product. For instance, it is believed that adding the synergists separately allows for better dispersion of the synergists within the polymer composition, especially when the synergist is present at elevated levels. In addition, it is believed that adding the synergists in two separate compounded components can improve processing of the melt blended product and can prevent fiber breakage. For instance, a pelletized product made according to the present disclosure that can be used to produce articles can have an average fiber length of greater than about 6 mm, such as greater than about 7 mm, such as greater than about 8 mm, such as greater than about 9 mm, such as even greater than about 10 mm. The average fiber length is generally less than about 50 mm, such as less than about 30 mm, such as less than about 20 mm, such as less than about 15 mm.

In one aspect, as described above, the synergist can comprise a metal salt of a phosphonic acid, a phosphonic acid, or mixtures thereof. The metal salt of the phosphonic acid can be an aluminum salt, a zinc salt, an iron salt, or mixtures thereof. In one aspect, the synergist is an aluminum salt of phosphonic acid.

When the synergist is a metal salt of a phosphonic acid and/or a phosphonic acid, the synergist can be present in the polymer composition in an amount greater than about 2% by weight, such as in an amount greater than about 2.3% by weight, such as in an amount greater than about 2.5% by weight, such as in an amount greater than about 2.7% by weight, such as in an amount greater than about 3% by weight, such as in an amount greater than about 3.3% by weight, such as in an amount greater than about 3.5% by weight, such as in an amount greater than about 3.8% by weight, such as in an amount greater than about 4% by weight. The synergist can be present in the polymer composition in an amount less than about 5% by weight, such as in an amount less than about 4.5% by weight, such as in an amount less than about 4% by weight.

In one aspect, the synergist comprises a mixture of a metal salt of a phosphonic acid and a phosphonic acid. The metal salt of the phosphonic acid can be present in the polymer composition in an amount greater than about 0.8% by weight, such as in an amount greater than about 1% by weight, such as in an amount greater than about 1.2% by weight, and in an amount less than about 1.8% by weight, such as in an amount less than about 1.6% by weight. The phosphonic acid, on the other hand, can be present in the polymer composition in an amount greater than about 1.2% by weight, such as in an amount greater than about 1.5% by weight, such as in an amount greater than about 1.7% by weight, such as in an amount greater than about 2% by weight, and in an amount less than about 2.8% by weight, such as in an amount less than about 2.6% by weight, such as in an amount less than about 2.4% by weight. When the synergist is a phosphonic acid and/or a metal salt of a phosphonic acid, the metal phosphinate can be present in the polymer composition in an amount greater than about 8% by weight, such as in an amount greater than about 10% by weight, such as in an amount greater than about 11% by weight, and in an amount less than about 18% by weight, such as in an amount less than about 16% by weight, such as in an amount less than about 14% by weight.

Optionally, the flame retardant system can also contain an inorganic compound. Suitable inorganic compounds (anhydrous or hydrates) may include, for instance, inorganic molybdates, such as zinc molybdate, calcium molybdate, ammonium octamolybdate, zinc molybdate-magnesium silicate, etc. Other suitable inorganic compounds may include inorganic borates, such as zinc borate, zinc phosphate, zinc hydrogen phosphate, zinc pyrophosphate, basic zinc chromate (VI) (zinc yellow), zinc chromite, zinc permanganate, silica, magnesium silicate, calcium silicate, calcium carbonate, titanium dioxide, magnesium dihydroxide, and so forth.

When present, one or more inorganic compounds can be present in the polymer composition in amounts less than about 2% by weight, such as in amounts less than about 1% by weight, such as in amounts less than about 0.8% by weight, such as in amounts less than about 0.6% by weight, and generally greater than about 0.05% by weight, such as greater than about 0.1% by weight, such as greater than about 0.2% by weight, such as greater than about 0.3% by weight.

### C. Other Components

In one aspect, the polymer composition can further contain at least one stabilizer. The stabilizer can include, for instance, an antioxidant.

The antioxidant, for instance, can be a phenolic antioxidant. In one embodiment, for instance, the composition can contain a phenolic antioxidant. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-cert-butyl-4-hydroxyhydrocinnamate (Irganox® 259); 1,2-bis(3,5,di-tert-butyI-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135): octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-3-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5,5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and the like.

In one embodiment, the antioxidant can be a reaction product of 2,4-di-tert-butylphenol, phosphorous trichloride, and 1,1′-biphenyl.

One or more antioxidants can be present in the polymer composition generally in an amount greater than about 0.05% by weight, such as in an amount greater than about 0.08% by weight, such as in an amount greater than about 0.1% by weight, such as in an amount greater than about 0.2% by weight, such as in an amount greater than about 0.4% by weight, and generally less than about 2% by weight, such as less than about 1.5% by weight, such as less than about 1% by weight, such as less than about 0.8% by weight, such as less than about 0.5% by weight, such as less than about 0.4% by weight.

The composition can optionally contain a heat stabilizer. In one embodiment, for instance, the heat stabilizer can comprise iodobis(triphenylphosphino) copper. Alternatively, the heat stabilizer can be a metal halide, such as a metal iodide. The metal iodide can be a potassium iodide, a copper iodide, or mixtures thereof.

In one aspect, the heat stabilizer can include a copper compound that can include a copper(I) salt, copper(II) salt, copper complex, or a combination thereof. For example, the copper(I) salt may be CuI, CuBr, CuCl, CuCN, CU₂O, or a combination thereof and/or the copper(II) salt may be copper acetate, copper stearate, copper sulfate, copper propionate, copper butyrate, copper lactate, copper benzoate, copper nitrate, CuO, CuCl₂, or a combination thereof. In certain embodiments, the copper compound may be a copper complex that contains an organic ligand, such as alkyl phosphines, such as trialkylphosphines (e.g., tris-(n-butyl)phosphine) and/or dialkylphosphines (e.g., 2-bis-(dimethylphosphino)-ethane); aromatic phosphines, such as triarylphosphines (e.g., triphenylphosphine or substituted triphenylphosphine) and/or diarylphosphines (e.g., 1,6-(bis-(diphenylphosphino))-hexane, 1,5-bis-(diphenylphosphino)-pentane, bis-(diphenylphosphino)methane, 1,2-bis-(diphenylphosphino)ethane, 1,3-bis-(diphenylphosphino)propane, 1,4-bis-(diphenylphosphino)butane, etc.); mercaptobenzimidazoles; glycines; oxalates; pyridines (e.g., bypyridines); amines (e.g., ethylenediaminetetraacetates, diethylenetriamines, triethylenetetramines, etc.); acetylacetonates; and so forth, as well as combinations of the foregoing. Particularly suitable copper complexes for use in the heat stabilizer may include, for instance, copper acetylacetonate, copper oxalate, copper EDTA, [Cu(PPh₃)₃X], [Cu₂X(PPH₃)₃], [Cu(PPh₃)X], [Cu(PPh₃)₂X], [CuX(PPh₃)-2,2′-bypyridine], [CuX(PPh₃)-2,2′-biquinoline)], or a combination thereof, wherein PPh₃ is triphenylphosphine and X is Cl, Br, I, CN, SCN, or 2-mercaptobenzimidazole. Other suitable complexes may likewise include 1,10-phenanthroline, o-phenylenebis(dimethylarsine), 1,2-bis(diphenylphosphino)-ethane, terpyridyl, and so forth.

When employed, the copper complexes may be formed by reaction of copper ions (e.g., copper(I) ions) with the organic ligand compound (e.g., triphenylphosphine or mercaptobenzimidazole compounds). For example, these complexes can be obtained by reacting triphenylphosphine with a copper(I) halide suspended in chloroform (G. Kosta, E. Reisenhofer and L. Stafani, J. Inorg. Nukl. Chem. 27 (1965) 2581). However, it is also possible to reductively react copper(II) compounds with triphenylphosphine to obtain the copper(I) addition compounds (F. U. Jardine, L. Rule, A. G. Vohrei, J. Chem. Soc. (A) 238-241 (1970)). However, the complexes used according to the invention can also be produced by any other suitable process. Suitable copper compounds for the preparation of these complexes are the copper(I) or copper(II) salts of the hydrogen halide acids, the hydrocyanic acid or the copper salts of the aliphatic carboxylic acids. Examples of suitable copper salts are copper (I) chloride, copper (I) bromide, copper (I) iodide, copper (I) cyanide, copper (II) chloride, copper (II) acetate, copper (II) stearate, etc., as well as combinations thereof. Copper(I)iodide and copper(I)cyanide are particularly suitable.

In addition to a copper compound, the heat stabilizer may also contain a halogen-containing synergist. When employed, the copper compound and halogen-containing synergist are typically used in quantities to provide a copper:halogen molar ratio of from about 1:1 to about 1:50, in some embodiments from about 1:4 to about 1:20, and in some embodiments, from about 1:6 to about 1:15. For example, the halogen content of the polymer composition may be from about 1 ppm to about 10,000 ppm, in some embodiments from about 50 ppm to about 5,000 ppm, in some embodiments from about 100 ppm to about 2,000 ppm, and in some embodiments, from about 300 ppm to about 1,500 ppm. In one aspect, the halogen content of the polymer composition is less than about 1000 ppm, such as less than about 600 ppm, such as less than about 500 ppm, such as less than about 400 ppm.

The halogenated synergist generally includes an organic halogen-containing compound, such as aromatic and/or aliphatic halogen-containing phosphates, aromatic and/or aliphatic halogen-containing hydrocarbons; and so forth, as well as combinations thereof. For example, suitable halogen-containing aliphatic phosphates may include tris(halohydrocarbyl)-phosphates and/or phosphonate esters. Tris(bromohydrocarbyl) phosphates (brominated aliphatic phosphates) are particularly suitable. In particular, in these compounds, no hydrogen atoms are attached to an alkyl C atom which is in the alpha position to a C atom attached to a halogen. This minimizes the extent that a dehydrohalogenation reaction can occur which further enhances stability of the polymer composition. Specific exemplary compounds are tris(3-bromo-2,2-bis(bromomethyl)propyl)phosphate, tris(dibromoneopentyl)phosphate, tris(trichloroneopentyl)phosphate, tris(bromodichlorneopentyl)phosphate, tris(chlordibromoneopentyl)phosphate, tris(tribromoneopentyl)phosphate, or a combination thereof. Suitable halogen-containing aromatic hydrocarbons may include halogenated aromatic polymers (including oligomers), such as brominated styrene polymers (e.g., polydibromostyrene, polytribromostyrene, etc.); halogenated aromatic monomers, such as brominated phenols (e.g., tetrabromobisphenol-A); and so forth, as well as combinations thereof.

The heat stabilizer can be present in the polymer composition generally in an amount greater than about 0.0001% by weight, such as in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 2.5% by weight, such as in an amount less than about 2% by weight, such as in an amount less than about 1.5% by weight, such as in an amount less than about 1% by weight, such as in an amount less than about 0.8% by weight. In one aspect, The resulting copper content of the polymer composition can be from about 1 ppm to about 1,000 ppm, in some embodiments from about 3 ppm to about 200 ppm, in some embodiments from about 5 ppm to about 150 ppm, and in some embodiments, from about 20 ppm to about 120 ppm.

The composition can optionally include a light stabilizer which may comprise a hindered amine light stabilizer. Examples of light stabilizers that may be incorporated into the present disclosure include a benzendicarboxamide. The light stabilizer may also comprise any compound which is derived from an alkylsubtituted piperidyl, piperidinyl or piperazinone compound or a substituted alkoxypiperidinyl. Other suitable HALS are those that are derivatives of 2,2,6,6-tetramethyl piperidine. Preferred specific examples of HALS include: ˜2,2,6,6-tetramethyl-4-piperidinone, ˜2,2,6,6-tetramethyl-4-piperidinol, ˜bis-(2,2,6,6-tetramethyl-4-piperidinyl)-sebacate, ˜mixtures of esters of 2,2,6,6-tetramethyl-4-piperidinol and fatty acids, ˜bis-(2,2,6,6-tetramethyl-4-piperidinyl)-succinate, ˜bis-(1-octyloxy-2,2,6,6-tetramethyl-4-piperidinyl)-sebacate, ˜bis-(1,2,2,6,6-pentamethyl-4-piperidinyl)-sebacate, ˜tetrakis-(2,2,6,6-tetramethyl-4-piperidyl)-1,2,3,4-butane-tetracarboxylate, ˜N-butyl-2,2,6,6-tetramethyl-4-piperidinamine, ˜N,N′-bis-(2,2,6,6-tetramethyl-4-piperidyl)-hexane-1,6-diamine, ˜2.2′-[(2.2.6.6-tetramethyl-4-piperidinyl)-imino]-bis-[ethanol], ˜5-(2.2.6.6-tetramethyl-4-piperidinyl)-2-cyclo-undecyl-oxazole), ˜mixture of: 2,2,4,4 tetramethyl-21-oxo-7-oxa-3.20-diazadispiro [5.1.11.2] heneicosane-20-propionic acid dodecylester and 2.2.4.4 tetramethyl-21-oxo-7; oxa-3,20-diazadispiro [5,1,11,2]-heneicosane-20-propionic acid; tetradecyl ester, ˜diacetam 5 (CAS registration number: 76505-58-3), ˜propanedioic acid, [(4-methoxyphenyl) methylene]-, bis(1,2,2,6,6-pentamethyl-4-piperidinyl) ester, ˜1,3-benzendicarboxamide, N,N′-bis (2,2,6,6-tetramethyl-4-piperidinyl), ˜3-dodecyl-1-(2,2,6,6-tetramethyl-4-piperidyl)-pyrrolidin-2,5-dione, ˜formamide, N,N′-1,6-hexanediylbis[N-(2,2,6,6-tetramethyl-4-piperidinyl, ˜3-dodecyl-1-(1,2,2,6,6-pentamethyl-4-piperidyl)-pyrrolidin-2,5-dione, ˜1,5-Dioxaspiro (5,5) undecane 3,3-dicarboxylic acid, bis (2,2,6,6-tetramethyl-4-peridinyl) ester, ˜1,5-Dioxaspiro (5,5) undecane 3,3-dicarboxylic acid, bis (1,2,2,6,6-pentamethyl-4-peridinyl) ester, ˜bis(1,2,2,6,6-pentamethyl-4-piperidyl)(3,5-di-t-butyl-4-hydroxybenzyl)-butylpropanedioate, ˜tetrakis-(1,2,2,6,6-penta-methyl-4-piperidyl)-1,2,3,4-butane-tetra- -carboxylate, ˜1,2,3,4-butanetetracarboxylic acid, tetrakis(2,2,6,6-tetramethyl-4-piperidinyl) ester, ˜1,2,3,4-butane-tetracarboxylic acid-1,2,3-tris (1,2,2,6,6-pentamethyl-4-piperidinyl)-4-tridecylester, ˜8-acetyl-3-dodecyl-7,7,9,9-tetra methyl-1,3,8-triazaspiro (4,5) decane-2,4-dione, ˜N-2,2,6,6-tetrametyl-4-piperidinyl-N-amino-oxamide, ˜4-acryloyloxy-1,2,2,6,6-pentamethyl-4-piperidine, -1,5,8,12-tetrakis [2′,4′-bis (1″,2″,2″,6″,6″-pentamethyl-4″-piperidinyl(butyl)amino)-1′,3′,5′-tr-iazin-6′-yl]-1,5,8,12-tetraazadodecane, ˜1,1′-(1,2-ethane-di-yl)-bis-(3,3′,5,5′-tetra-methyl-piperazinone) (Good rite 3034), ˜propane amide, 2-methyl-N-(2,2,6,6-tetramethyl-4-piperidinyl)-2-[(2,2,6,6-tetramethyl-4-piperidinyl)amino], ˜oligomer of N-(2-hydroxyethyl)-2,2,6,6-tetramethyl-4-piperidinol and succinic acid, ˜poly [[6-[(1,1,3,3-tetramethylbutypamino]-s-triazine-2,4-diyl][2,2,6,6-tetram-ethyl-4-piperidinyl)imino] hexamethylene [(2,2,6,6-tetramethyl-4-piperidinyl)imino]], ˜poly [(6-morfoline-S-triazine-2.4-diyl) [(2.2.6.6-tetramethyl-4-piperidinyl)-imino]hexamethylene-[(2.2.6.6-tetram-ethyl-4-piperidinyl)-imino]], ˜poly [(6-morpholino-s-triazine-2.4-diyl) [1.2.2.6.6-penta-methyl-4-piperidyl) imino]-hexamethylene [(2,2,6,6 tetra-methyl-4-piperidyl) imino]], ˜poly methylpropyl-3-oxy-[4(2.2.6.6-tetrametyl)-piperidinyl)]-siloxane copolymer of a-methylstyrene and n-(2.2.6.6-tetramethyl-piperidinyl)-4-maleimide and N-stearyl-maleimide, ˜1,2,3,4-butane tetracarboxylic acid, polymer with 8,8,8′,8′-tetramethyl-2,4,8,10-tetraoxaspiro [5,5] undecane-3,9-diethanol, 1,2,2,6,6-pentamethyl-4-piperidinyl ester, ˜1,2,3,4-butanetetracarboxylic acid, polymer with 8,8,8′,8′-tetramethyl-2,4,8,10-tetraoxaspiro [5,5] undecane-3,9-diethanol, 2,2,6,6-tetramethyl-4-piperidinyl ester, -oligomer of 7-Oxa-3,20-diazadispiro [5,1,11,2] heneicosan-21-one, 2,2,4,4-tetramethyl-20-(oxiranylmethyl), ˜1,3,5-Triazine-2,4,6-triamine, N,N″-[1,2-ethanediylbis [[[4,6-bis[butyl(1,2,2,6,6-pentamethyl-4-iperidinyl)amino]-1,3,5-triazine- -2-yl]imino]-3,1-propanediyl]]-bis [N.N″-dibutyl-N.N″-bis(1.2.2.6.6-pentamethyl-4-piperidinyl), ˜1.3-Propanediamine, N,N-1,2-ethanediylbis-, polymer with 2,4,6-trichloro-1,3,5-triazine, reaction products with N-butyl-2,2,6,6-tetramethyl-4-piperidinamine, ˜1.6-Hexanediamine, N,N′-bis (2,2,6,6-tetramethyl-4piperidinyl)-polymer with 2,4,6-trichloro-1,3,5-triazine, reaction products with N-butyl-1-butanamine and N-butyl-2,2,6,6-tetramethyl-4-piperidinamine, ˜2,9,11,13,15,22,24,26,27,28-Decaazatricyclo [21,3,1,110,14]octacosa-1(27), 10,12,14(28),23,25-hexaene-12, 25-diamine, N,N′-bis (1,1,3,3-tetramethylbutyl)-2,9,15,22-tetrakis (2,2,6,6-tetramethyl-4-piperidinyl)-, ˜1,1,1″-(1,3,5-Triazine-2,4,6-triyltris ((cyclohexylimino)-2,1-ethanediyl) tris (3,3,5,5-tetramethylpiperazinone), ˜1,1,1″-(1,3,5-Triazine-2,4,6-triyltris((cyclohexylimino)-2,1-ethylenediyl) tris (3,3,4,5,5-tetramethylpiperazinone), ˜1,6-hexanediamine, N,N′-bis (2,2,6,6-tetramethyl-4-piperidinyl)-, polymer with 2,4,6-trichloro-1,3,5-triazine, reaction products with 3-bromo-1-propene, nbutyl-1-butanamine and N-butyl-2,2,6,6-tetramethyl-4-piperidinamine, oxidised, hydrogenated, ˜Alkenes, (C20-24)-4 alpha-, polymers with maleic anhydride, reaction products with 2,2,6,6-tetramethyl-4-piperidinamine, ˜N-2,2,6,6-tetramethyl-4-piperidinyl-N-amino-oxamide; 4-acryloyloxy-1,2,2,6,6-pentamethyl-4-piperidine; HALS PB-41 or mixtures thereof.

One or more light stabilizers can generally be present in the composition in an amount greater than about 0.01% by weight, such as in an amount greater than about 0.05% by weight, such as in an amount greater than about 0.08% by weight, and generally in an amount less than about 2% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

In addition to the components noted above, the polymer matrix may also contain a variety of other components. Examples of such optional components may include, for instance, EMI fillers, compatibilizers, particulate fillers, lubricants, colorants, flow modifiers, pigments, and other materials added to enhance properties and processability. When EMI shielding properties are desired, for instance, an EMI filler may be employed. The EMI filler is generally formed from an electrically conductive material that can provide the desired degree of electromagnetic interference shielding. In certain embodiments, for instance, the material contains a metal, such as stainless steel, aluminum, zinc, iron, copper, silver, nickel, gold, chrome, etc., as well alloys or mixtures thereof. The EMI filler may also possess a variety of different forms, such as particles (e.g., iron powder), flakes (e.g., aluminum flakes, stainless steel flakes, etc.), or fibers. Particularly suitable EMI fillers are fibers that contain a metal. In such embodiments, the fibers may be formed from primarily from the metal (e.g., stainless steel fibers) or the fibers may be formed from a core material that is coated with the metal. When employing a metal coating, the core material may be formed from a material that is either conductive or insulative in nature. For example, the core material may be formed from carbon, glass, or a polymer. One example of such a fiber is nickel-coated carbon fibers.

In one aspect, a lubricant can be present in the polymer composition. Any suitable lubricant can be incorporated into the polymer composition. In one aspect, the lubricant can comprise a partially saponified ester wax. For example, the lubricant can comprise a partially saponified ester wax of a C22 to C36 fatty acid. The fatty acid, for instance, can comprise a montan wax. In one aspect, the lubricant can contain 1-methyl-1,3-propanediylesters. In another aspect, the lubricant can be a fatty acid amide, including fatty primary amides, fatty secondary amides, and the like. Other suitable lubricants include metal salts of fatty acids, such as calcium stearate, aluminum distearate, zinc stearate, magnesium stearate, and mixtures thereof. The lubricant can be present in the polymer composition generally in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 3% by weight, such as in an amount less than about 2.5% by weight, such as in an amount less than about 2% by weight, such as in an amount less than about 1.5% by weight, such as in an amount less than about 1% by weight, such as in an amount less than about 0.8% by weight.

A compatibilizer may also be employed to enhance the degree of adhesion between the long fibers with the polymer matrix. When employed, such compatibilizers typically constitute from about 0.1 wt. % to about 15 wt. %, in some embodiments from about 0.5 wt. % to about 10 wt. %, and in some embodiments, from about 1 wt. % to about 5 wt. % of the polymer composition. In certain embodiments, the compatibilizer may be a polyolefin compatibilizer that contains a polyolefin that is modified with a polar functional group. The polyolefin may be an olefin homopolymer (e.g., polypropylene) or copolymer (e.g., ethylene copolymer, propylene copolymer, etc.). The functional group may be grafted onto the polyolefin backbone or incorporated as a monomeric constituent of the polymer (e.g., block or random copolymers), etc. Particularly suitable functional groups include maleic anhydride, maleic acid, fumaric acid, maleimide, maleic acid hydrazide, a reaction product of maleic anhydride and diamine, dichloromaleic anhydride, maleic acid amide, etc.

In one embodiment, a coloring agent may optionally be incorporated into the polymer composition. The coloring agent, for instance, can be a black pigment such as carbon black or a black dye. The coloring agent can be present in the polymer composition in an amount greater than about 0.5% by weight, such as in an amount greater than about 0.7% by weight, and in an amount less than about 2% by weight, such as in an amount less than about 1.5% by weight, such as in an amount less than about 1.3% by weight.

Regardless of the particular components employed, the raw materials (e.g., thermoplastic polymers, flame retardants, stabilizers, compatibilizers, etc.) are typically melt blended together to form the polymer matrix prior to being reinforced with the long fibers. The raw materials may be supplied either simultaneously or in sequence to a melt-blending device that dispersively blends the materials. Batch and/or continuous melt blending techniques may be employed. For example, a mixer/kneader, Banbury mixer, Farrel continuous mixer, single-screw extruder, twin-screw extruder, roll mill, etc., may be utilized to blend the materials. One particularly suitable melt-blending device is a co-rotating, twin-screw extruder (e.g., ZSK-30 twin-screw extruder available from Werner & Pfleiderer Corporation of Ramsey, N.J.). Such extruders may include feeding and venting ports and provide high intensity distributive and dispersive mixing. For example, the thermoplastic polymer may be fed to a feeding port of the twin-screw extruder and melted. Thereafter, the stabilizers may be injected into the polymer melt. Alternatively, the stabilizers may be separately fed into the extruder at a different point along its length. Regardless of the particular melt blending technique chosen, the raw materials are blended under high shear/pressure and heat to ensure sufficient mixing. For example, melt blending may occur at a temperature of from about 150° C. to about 300° C., in some embodiments, from about 155° C. to about 250° C., and in some embodiments, from about 160° C. to about 220° C.

### II. Long Fibers

To form the fiber-reinforced composition of the present invention, long fibers are generally embedded within the polymer matrix. Long fibers may, for example, constitute from about 10 wt. % to about 70 wt. %, in some embodiments from about 12 wt. % to about 38 wt. %, and in some embodiments, from about 15 wt. % to about 35 wt. % of the composition. When continuous fibers are used to produce tapes, the fibers can comprise from about 50% by weight to about 70% by weight of the composite. The polymer matrix typically constitutes from about 30 wt. % to about 90 wt. %, in some embodiments from about 45 wt. % to about 70 wt. %, and in some embodiments, from about 50 wt. % to about 65 wt. % of the composition.

The term “long fibers” generally refers to fibers, filaments, yarns, or rovings (e.g., bundles of fibers) that can be continuous or have a length of from about 1 to about 50 millimeters, in some embodiments, from about 1.5 to about 20 millimeters, in some embodiments from about 2 to about 15 millimeters, and in some embodiments, from about 3 to about 12 millimeters. A substantial portion of the fibers may maintain a relatively large length even after being formed into a shaped part (e.g., injection molding). That is, the median length (D50) of the fibers in the composition may be about 1 millimeter or more, in some embodiments about 1.5 millimeters or more, in some embodiments about 2.0 millimeters or more, and in some embodiments, from about 2.5 to about 15 millimeters. As described above, the flame retardant system and/or the manner in which the flame retardant system is incorporated into the polymer composition can, in some embodiments, preserve fiber length. Thus, in one aspect, the average fiber length in a pelletized product can be greater than about 4 mm, such as greater than about 5 mm, such as greater than about 6 mm, such as greater than about 7 mm, such as greater than about 8 mm, such as greater than about 9 mm, such as greater than about 10 mm, and generally less than about 30 mm, such as less than about 20 mm, such as less than about 15 mm.

Regardless of their length, the nominal diameter of the fibers (e.g., diameter of fibers within a roving) may be selectively controlled to help improve the surface appearance of the resulting polymer composition. More particularly, the nominal diameter of the fibers may range from about 20 to about 40 micrometers, in some embodiments from about 20 to about 30 micrometers, and in some embodiments, from about 21 to about 26 micrometers. Within this range, the tendency of the fibers to become “clumped” on the surface of a shaped part is reduced, which allows the color and the surface appearance of the part to predominantly stem from the polymer matrix. In addition to providing improved aesthetic consistency, it also allows the color to be better maintained after exposure to ultraviolet light as a stabilizer system can be more readily employed within the polymer matrix. Of course, it should be understood that other nominal diameters may be employed, such as those from about 1 to about 20 micrometers, in some embodiments from about 8 to about 19 micrometers, and in some embodiments, from about 10 to about 18 micrometers.

The fibers may be formed from any conventional material known in the art, such as metal fibers; glass fibers (e.g., E-glass, A-glass, C-glass, D-glass, AR-glass, R-glass, S1-glass, S2-glass), carbon fibers (e.g., graphite), boron fibers, ceramic fibers (e.g., alumina or silica), aramid fibers (e.g., Kevlar®), synthetic organic fibers (e.g., polyamide, polyethylene, paraphenylene, terephthalamide, polyethylene terephthalate and polyphenylene sulfide), metal fibers as described above (e.g., stainless fibers), and various other natural or synthetic inorganic or organic fibrous materials known for reinforcing thermoplastic compositions. Glass fibers, and particularly S-glass fibers, are particularly desirable. The fibers may be twisted or straight. If desired, the fibers may be in the form of rovings (e.g., bundle of fibers) that contain a single fiber type or different types of fibers. Different fibers may be contained in individual rovings or, alternatively, each roving may contain a different fiber type. For example, in one embodiment, certain rovings may contain carbon fibers, while other rovings may contain glass fibers. The number of fibers contained in each roving can be constant or vary from roving to roving. Typically, a roving may contain from about 1,000 fibers to about 50,000 individual fibers, and in some embodiments, from about 2,000 to about 40,000 fibers.

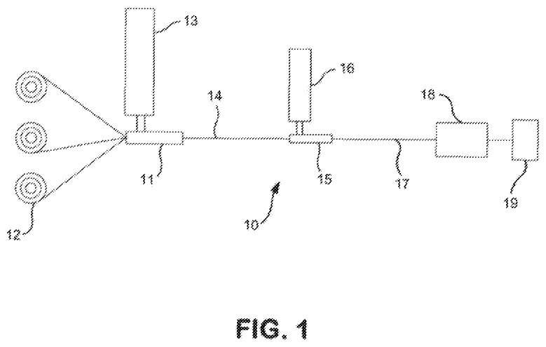

Any of a variety of different techniques may generally be employed to incorporate the fibers into the polymer matrix. The long fibers may be randomly distributed within the polymer matrix, or alternatively distributed in an aligned fashion. In one embodiment, for instance, continuous fibers may initially be impregnated into the polymer matrix to form strands, which are thereafter cooled and then chopped into pellets to that the resulting fibers have the desired length for the long fibers. In such embodiments, the polymer matrix and continuous fibers (e.g., rovings) are typically pultruded through an impregnation die to achieve the desired contact between the fibers and the polymer. Pultrusion can also help ensure that the fibers are spaced apart and aligned in the same or a substantially similar direction, such as a longitudinal direction that is parallel to a major axis of the pellet (e.g., length), which further enhances the mechanical properties. Referring to FIG. 1, for instance, one embodiment of a pultrusion process 10 is shown in which a polymer matrix is supplied from an extruder 13 to an impregnation die 11 while continuous fibers 12 are a pulled through the die 11 via a puller device 18 to produce a composite structure 14. Typical puller devices may include, for example, caterpillar pullers and reciprocating pullers. While optional, the composite structure 14 may also be pulled through a coating die 15 that is attached to an extruder 16 through which a coating resin is applied to form a coated structure 17. As shown in FIG. 1, the coated structure 17 is then pulled through the puller assembly 18 and supplied to a pelletizer 19 that cuts the structure 17 into the desired size for forming the long fiber-reinforced composition.

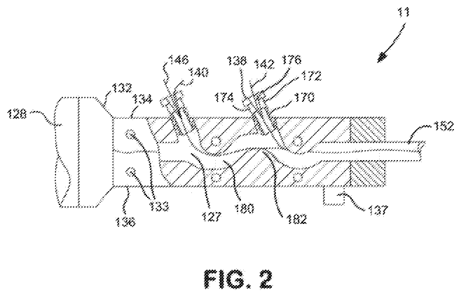

The nature of the impregnation die employed during the pultrusion process may be selectively varied to help achieved good contact between the polymer matrix and the long fibers. Examples of suitable impregnation die systems are described in detail in Reissue Patent No. 32,772 to Hawley; U.S. Pat. No. 9,233,486 to Regan, et al.; and U.S. Pat. No. 9,278,472 to Eastep, et al. Referring to FIG. 2, for instance, one embodiment of such a suitable impregnation die 11 is shown. As shown, a polymer matrix 127 may be supplied to the impregnation die 11 via an extruder (not shown). More particularly, the polymer matrix 127 may exit the extruder through a barrel flange 128 and enter a die flange 132 of the die 11. The die 11 contains an upper die half 134 that mates with a lower die half 136. Continuous fibers 142 (e.g., roving) are supplied from a reel 144 through feed port 138 to the upper die half 134 of the die 11. Similarly, continuous fibers 146 are also supplied from a reel 148 through a feed port 140. The matrix 127 is heated inside die halves 134 and 136 by heaters 133 mounted in the upper die half 134 and/or lower die half 136. The die is generally operated at temperatures that are sufficient to cause melting and impregnation of the thermoplastic polymer. Typically, the operation temperature of the die is higher than the melt temperature of the polymer matrix. When processed in this manner, the continuous fibers 142 and 146 become embedded in the matrix 127. The mixture is then pulled through the impregnation die 11 to create a fiber-reinforced composition 152. If desired, a pressure sensor 137 may also sense the pressure near the impregnation die 11 to allow control to be exerted over the rate of extrusion by controlling the rotational speed of the screw shaft, or the federate of the feeder.

Within the impregnation die, it is generally desired that the fibers contact a series of impingement zones. At these zones, the polymer melt may flow transversely through the fibers to create shear and pressure, which significantly enhances the degree of impregnation. This is particularly useful when forming a composite from ribbons of a high fiber content. Typically, the die will contain at least 2, in some embodiments at least 3, and in some embodiments, from 4 to 50 impingement zones per roving to create a sufficient degree of shear and pressure. Although their particular form may vary, the impingement zones typically possess a curved surface, such as a curved lobe, rod, etc. The impingement zones are also typically made of a metal material.

FIG. 2 shows an enlarged schematic view of a portion of the impregnation die 11 containing multiple impingement zones in the form of lobes 182. It should be understood that this invention can be practiced using a plurality of feed ports, which may optionally be coaxial with the machine direction. The number of feed ports used may vary with the number of fibers to be treated in the die at one time and the feed ports may be mounted in the upper die half 134 or the lower die half 136. The feed port 138 includes a sleeve 170 mounted in upper die half 134. The feed port 138 is slidably mounted in a sleeve 170. The feed port 138 is split into at least two pieces, shown as pieces 172 and 174. The feed port 138 has a bore 176 passing longitudinally therethrough. The bore 176 may be shaped as a right cylindrical cone opening away from the upper die half 134. The fibers 142 pass through the bore 176 and enter a passage 180 between the upper die half 134 and lower die half 136. A series of lobes 182 are also formed in the upper die half 134 and lower die half 136 such that the passage 210 takes a convoluted route. The lobes 182 cause the fibers 142 and 146 to pass over at least one lobe so that the polymer matrix inside the passage 180 thoroughly contacts each of the fibers. In this manner, thorough contact between the molten polymer and the fibers 142 and 146 is assured.

To further facilitate impregnation, the fibers may also be kept under tension while present within the impregnation die. The tension may, for example, range from about 5 to about 300 Newtons, in some embodiments from about 50 to about 250 Newtons, and in some embodiments, from about 100 to about 200 Newtons per tow of fibers. Furthermore, the fibers may also pass impingement zones in a tortuous path to enhance shear. For example, in the embodiment shown in FIG. 2, the fibers traverse over the impingement zones in a sinusoidal-type pathway. The angle at which the rovings traverse from one impingement zone to another is generally high enough to enhance shear, but not so high to cause excessive forces that will break the fibers. Thus, for example, the angle may range from about 1° to about 30°, and in some embodiments, from about 5° to about 25°.

The impregnation die shown and described above is but one of various possible configurations that may be employed in the present invention. In alternative embodiments, for example, the fibers may be introduced into a crosshead die that is positioned at an angle relative to the direction of flow of the polymer melt. As the fibers move through the crosshead die and reach the point where the polymer exits from an extruder barrel, the polymer is forced into contact with the fibers. It should also be understood that any other extruder design may also be employed, such as a twin screw extruder. Still further, other components may also be optionally employed to assist in the impregnation of the fibers. For example, a “gas jet” assembly may be employed in certain embodiments to help uniformly spread a bundle or tow of individual fibers, which may each contain up to as many as 24,000 fibers, across the entire width of the merged tow. This helps achieve uniform distribution of strength properties in the ribbon. Such an assembly may include a supply of compressed air or another gas that impinges in a generally perpendicular fashion on the moving fiber tows that pass across the exit ports. The spread fiber bundles may then be introduced into a die for impregnation, such as described above.

The fiber-reinforced polymer composition may generally be employed to form a shaped part using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the fiber-reinforced composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the fiber-reinforced composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity. Due to the unique properties of the fiber-reinforced composition, relatively thin shaped parts (e.g., injection molded parts) can be readily formed therefrom. For example, such parts may have a thickness of about 10 millimeters or less, in some embodiments about 8 millimeters or less, in some embodiments about 6 millimeters or less, in some embodiments from about 0.4 to about 5 millimeters, and in some embodiments, from about 0.8 to about 4 millimeters (e.g., 0.8, 1.2. or 3 millimeters).

### II. Applications

Due to its unique properties, the fiber-reinforced polymer composition of the present disclosure can be used in all different types of applications. For instance, the fiber-reinforced polymer composition displays excellent flame retardant properties with improved mechanical properties. In one aspect, the composition can also display excellent thermal stability. The polymer composition can produce articles at relatively low weights while having excellent dimensional control. Articles formed with the polymer composition can have relatively thin walls and can possess excellent impact resistance strength and high temperature performance. The polymer composition also displays excellent creep and fatigue properties. In addition, the polymer composition can be formulated to have excellent electrical properties.

For exemplary purposes only, in one aspect, the long fiber-reinforced polymer composition can be used to produce components in various different electrical devices and systems.

In certain embodiments, for instance, the device may be an electronic module that contains a housing that receives one or more electronic components (e.g., printed circuit board, antenna elements, radio frequency sensing elements, sensors, light sensing and/or transmitting elements (e.g., fibers optics), cameras, global positioning devices, etc.). The housing may, for instance, include a base that contains a sidewall extending therefrom. A cover may also be supported on the sidewall of the base to define an interior within which the electronic component(s) are received and protected from the exterior environment. Regardless of the particular configuration of the module, the polymer composition of the present invention may be used to form all or a portion of the housing and/or cover. In one embodiment, for instance, the polymer composition of the present invention may be used to form the base and sidewall of the housing. In such embodiments, the cover may be formed from the polymer composition of the present invention or from a different material, such as a metal component (e.g., aluminum plate).

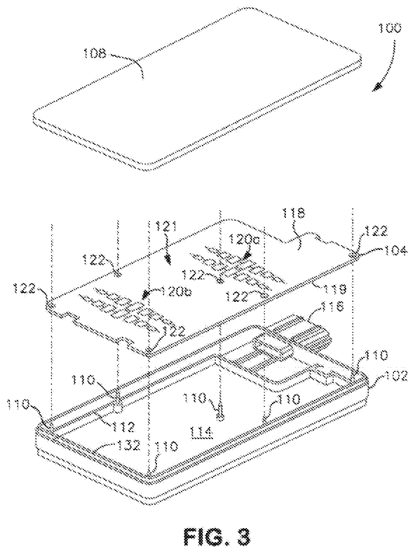

Referring to FIG. 3, for instance, one particular embodiment of an electronic module 100 is shown that may incorporate the polymer composition of the present invention. The electronic module 100 includes a housing 102 that contains sidewalls 132 extending from a base 114. If desired, the housing 102 may also contain a shroud 116 that can accommodate an electrical connector (not shown). Regardless, a printed circuit board (“PCB”) is received within the interior of the module 100 and attached to housing 102. More particularly, the circuit board 104 contains holes 122 that are aligned with and receive posts 110 located on the housing 102. The circuit board 104 has a first surface 118 on which electrical circuitry 121 is provided to enable radio frequency operation of the module 100. For example, the RF circuitry 121 can include one or more antenna elements 120a and 120b. The circuit board 104 also has a second surface 119 that opposes the first surface 118 and may optionally contain other electrical components, such as components that enable the digital electronic operation of the module 100 (e.g., digital signal processors, semiconductor memories, input/output interface devices, etc.). Alternatively, such components may be provided on an additional printed circuit board. A cover 108 may also be employed that is disposed over the circuit board 104 and attached to the housing 102 (e.g., sidewall) through known techniques, such as by welding, adhesives, etc., to seal the electrical components within the interior. As indicated above, the polymer composition may be used to form all or a portion of the cover 108 and/or the housing 102.

The electronic module may be used in a wide variety of applications. For example, the electronic module may be employed in an automotive vehicle (e.g., electric vehicle). When used in automotive applications, for instance, the electronic module may be used to sense the positioning of the vehicle relative to one or more three-dimensional objects. In this regard, the module may contain radio frequency sensing components, light detection or optical components, cameras, antenna elements, etc., as well as combinations thereof. For example, the module may be a radio detection and ranging (“radar”) module, light detection and ranging (“lidar”) module, camera module, global positioning module, etc., or it may be an integrated module that combines two or more of these components. Such modules may thus employ a housing that receives one or more types of electronic components (e.g., printed circuit board, antenna elements, radio frequency sensing devices, sensors, light sensing and/or transmitting elements (e.g., fibers optics), cameras, global positioning devices, etc.). In one embodiment, for example, a lidar module may be formed that contains a fiber optic assembly for receiving and transmitting light pulses that is received within the interior of a housing/cover assembly in a manner similar to the embodiments discussed above. Similarly, a radar module typically contains one or more printed circuit boards having electrical components dedicated to handling radio frequency (RF) radar signals, digital signal processing tasks, etc.

The electronic module may also be employed in a 5G system. For example, the electronic module may be an antenna module, such as macrocells (base stations), small cells, microcells or repeaters (femtocells), etc. As used herein, “5G” generally refers to high speed data communication over radio frequency signals. 5G networks and systems are capable of communicating data at much faster rates than previous generations of data communication standards (e.g., “4G, “LTE”). Various standards and specifications have been released quantifying the requirements of 5G communications. As one example, the International Telecommunications Union (ITU) released the International Mobile Telecommunications-2020 (“IMT-2020”) standard in 2015. The IMT-2020 standard specifies various data transmission criteria (e.g., downlink and uplink data rate, latency, etc.) for 5G. The IMT-2020 Standard defines uplink and downlink peak data rates as the minimum data rates for uploading and downloading data that a 5G system must support. The IMT-2020 standard sets the downlink peak data rate requirement as 20 Gbit/s and the uplink peak data rate as 10 Gbit/s. As another example, 3^{rd} Generation Partnership Project (3GPP) recently released new standards for 5G, referred to as “5G NR.” 3GPP published “Release 15” in 2018 defining “Phase 1” for standardization of 5G NR. 3GPP defines 5G frequency bands generally as “Frequency Range 1” (FR1) including sub-6 GHz frequencies and “Frequency Range 2” (FR2) as frequency bands ranging from 20-60 GHz. However, as used herein “5G frequencies” can refer to systems utilizing frequencies greater than 60 GHz, for example ranging up to 80 GHz, up to 150 GHz, and up to 300 GHz. As used herein, “5G frequencies” can refer to frequencies that are about 1.8 GHz or more, in some embodiments about 2.0 GHz or more, in some embodiments about 3.0 GHz or higher, in some embodiments from about 3 GHz to about 300 GHz, or higher, in some embodiments from about 4 GHz to about 80 GHz, in some embodiments from about 5 GHz to about 80 GHz, in some embodiments from about 20 GHz to about 80 GHz, and in some embodiments from about 28 GHz to about 60 GHz.

5G antenna systems generally employ high frequency antennas and antenna arrays for use in a 5G component, such as macrocells (base stations), small cells, microcells or repeaters (femtocell), etc., and/or other suitable components of 5G systems. The antenna elements/arrays and systems can satisfy or qualify as “5G” under standards released by 3GPP, such as Release 15 (2018), and/or the IMT-2020 Standard. To achieve such high speed data communication at high frequencies, antenna elements and arrays generally employ small feature sizes/spacing (e.g., fine pitch technology) that can improve antenna performance. For example, the feature size (spacing between antenna elements, width of antenna elements) etc. is generally dependent on the wavelength (“λ”) of the desired transmission and/or reception radio frequency propagating through the substrate on which the antenna element is formed (e.g., nλ/4 where n is an integer). Further, beamforming and/or beam steering can be employed to facilitate receiving and transmitting across multiple frequency ranges or channels (e.g., multiple-in-multiple-out (MIMO), massive MIMO). The high frequency 5G antenna elements can have a variety of configurations. For example, the 5G antenna elements can be or include co-planar waveguide elements, patch arrays (e.g., mesh-grid patch arrays), other suitable 5G antenna configurations. The antenna elements can be configured to provide MIMO, massive MIMO functionality, beam steering, etc. As used herein “massive” MIMO functionality generally refers to providing a large number transmission and receiving channels with an antenna array, for example 8 transmission (Tx) and 8 receive (Rx) channels (abbreviated as 8×8). Massive MIMO functionality may be provided with 8×8, 12×12, 16×16, 32×32, 64×64, or greater.

The antenna elements may be fabricated using a variety of manufacturing techniques. As one example, the antenna elements and/or associated elements (e.g., ground elements, feed lines, etc.) can employ fine pitch technology. Fine pitch technology generally refers to small or fine spacing between their components or leads. For example, feature dimensions and/or spacing between antenna elements (or between an antenna element and a ground plane) can be about 1,500 micrometers or less, in some embodiments 1,250 micrometers or less, in some embodiments 750 micrometers or less (e.g., center-to-center spacing of 1.5 mm or less), 650 micrometers or less, in some embodiments 550 micrometers or less, in some embodiments 450 micrometers or less, in some embodiments 350 micrometers or less, in some embodiments 250 micrometers or less, in some embodiments 150 micrometers or less, in some embodiments 100 micrometers or less, and in some embodiments 50 micrometers or less. However, it should be understood that feature sizes and/or spacings that are smaller and/or larger may also be employed. As a result of such small feature dimensions, antenna configurations and/or arrays can be achieved with a large number of antenna elements in a small footprint. For example, an antenna array can have an average antenna element concentration of greater than 1,000 antenna elements per square centimeter, in some embodiments greater than 2,000 antenna elements per square centimeter, in some embodiments greater than 3,000 antenna elements per square centimeter, in some embodiments greater than 4,000 antenna elements per square centimeter, in some embodiments greater than 6,000 antenna elements per square centimeter, and in some embodiments greater than about 8,000 antenna elements per square centimeter. Such compact arrangement of antenna elements can provide a greater number of channels for MIMO functionality per unit area of the antenna area. For example, the number of channels can correspond with (e.g., be equal to or proportional with) the number of antenna elements.

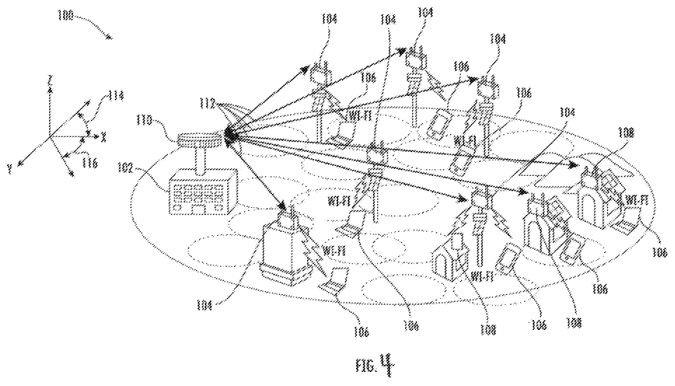

Referring to FIG. 4, for example, a 5G antenna system 100 can include a base station 102, one or more relay stations 104, one or more user computing devices 106, one or more Wi-Fi repeaters 108 (e.g., “femtocells”), and/or other suitable antenna components for the 5G antenna system 100. The relay stations 104 can be configured to facilitate communication with the base station 102 by the user computing devices 106 and/or other relay stations 104 by relaying or “repeating” signals between the base station 102 and the user computing devices 106 and/or relay stations 104. The base station 102 can include a MIMO antenna array 110 configured to receive and/or transmit radio frequency signals 112 with the relay station(s) 104, Wi-Fi repeaters 108, and/or directly with the user computing device(s) 106. The user computing device 306 is not necessarily limited by the present invention and include devices such as 5G smartphones. The MIMO antenna array 110 can employ beam steering to focus or direct radio frequency signals 112 with respect to the relay stations 104. For example, the MIMO antenna array 110 can be configured to adjust an elevation angle 114 with respect to an X-Y plane and/or a heading angle 116 defined in the Z-Y plane and with respect to the Z direction. Similarly, one or more of the relay stations 104, user computing devices 106, Wi-Fi repeaters 108 can employ beam steering to improve reception and/or transmission ability with respect to MIMO antenna array 110 by directionally tuning sensitivity and/or power transmission of the device 104, 106, 108 with respect to the MIMO antenna array 110 of the base station 102 (e.g., by adjusting one or both of a relative elevation angle and/or relative azimuth angle of the respective devices).

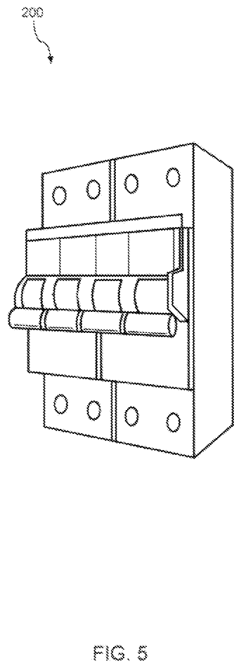

In other embodiments, the long fiber-reinforced polymer composition of the present disclosure can be used to produce housings for electrical components that may be contained in industrial settings, residential settings, or within all different types of vehicles including automobiles, trucks, planes, trains, and the like. For example, referring to FIG. 5, a circuit breaker 200 is shown. The circuit breaker contains electrical components that are placed within a circuit. The flame retardant and long fiber-reinforced polymer composition of the present disclosure can be used to construct an insulating component within the circuit breaker 200 or can be used to construct all or a portion of the housing of the circuit breaker 200.

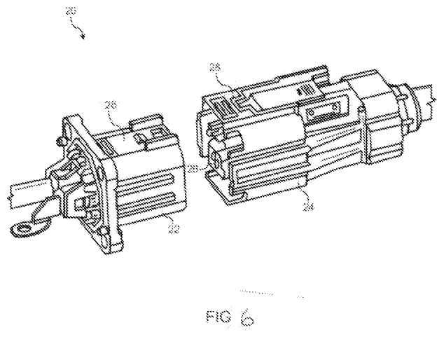

Referring to FIG. 6, a high voltage electrical connector generally 20 is shown. The connector 20 includes a first connector component 22 that is inserted into and interlocks with a second connector component 24. The electrical connector 20 can include an electrically conductive component 26 that is surrounded by a polymer component 28. The polymer component 28 can be made from the flame retardant polymer composition of the present disclosure. As shown in FIG. 6, the electrical connector 20 can have a complex shape with thin walls in certain areas. Due to the melt flow properties of the polymer composition of the present disclosure, the composition is well suited to forming the electrical connector 20 as shown in FIG. 6 through any suitable molding process, such as injection molding.

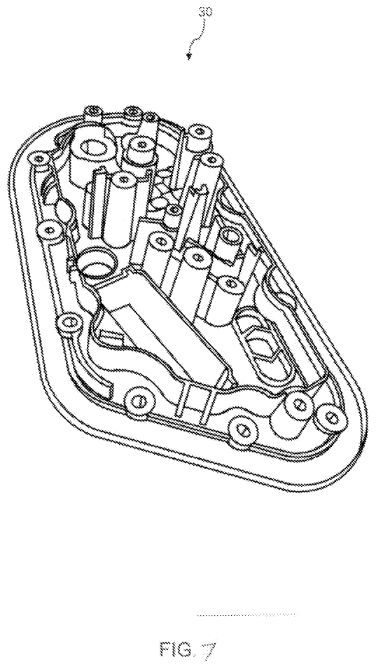

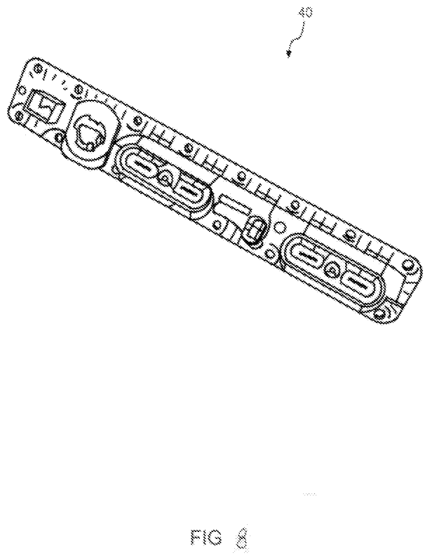

In one embodiment, the polymer composition of the present disclosure can also be used to produce housings that contain electrical components. For example, referring to FIG. 7, a portion of a battery housing 30 is shown. The battery housing 30 can include various different complex shapes that can all be molded from the flame retardant polymer composition of the present disclosure. Similarly, FIG. 8 illustrates a battery plug board 40 that can also be molded from the polymer composition of the present disclosure. The battery plug board 40 can, in one embodiment, form a portion of the housing of the battery and can be used to connect the battery to an electrical connector.

The long fiber reinforced polymer composition of the present disclosure can also be used to produce covers, trays, and bracketing and cell modules. These components, in one aspect, can be incorporated into an electric vehicle, such as the battery system as described above. The battery housing, for instance, can be a battery housing for multiple lithium ion cells.

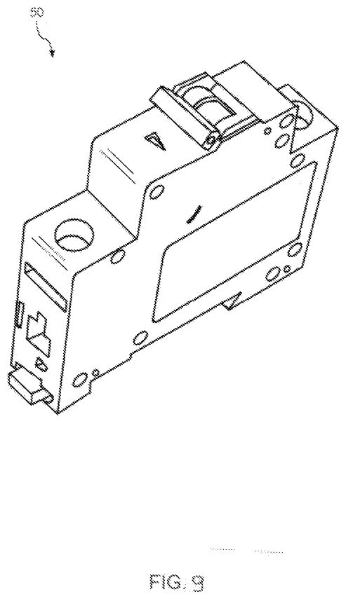

In another embodiment, a single switch circuit breaker 50 is shown in FIG. 9. The circuit breaker contains electrical components that are placed within a circuit at a residential household, an industrial facility, or the like. The flame retardant polymer composition of the present disclosure can be used to construct an insulating component within the circuit breaker 50, can construct the housing of the circuit breaker 50, or can also be used to form the switches on the circuit breaker 50.

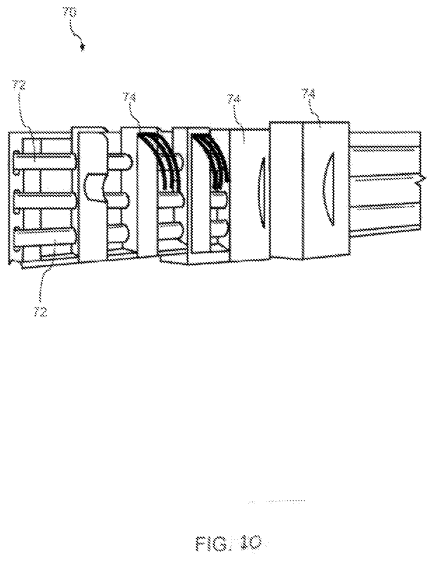

Referring to FIG. 10, a contact rail 70 is illustrated. The contact rail 70 includes conductive members 72. The contact rail 70 is configured to make direct contact with conducting power rails. As shown in FIG. 10, the contact rail 70 includes polymer components 74 that can be made from the flame retardant polymer composition of the present disclosure.

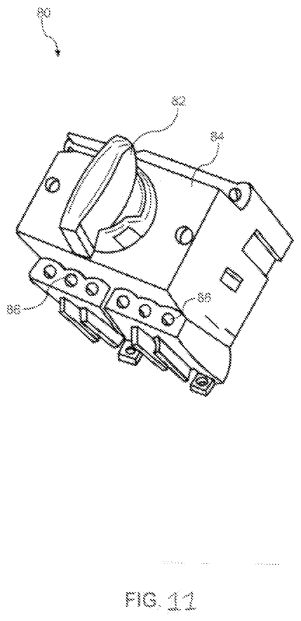

Referring to FIG. 11, an electrical switch 80 made in accordance with the present disclosure is shown. The electrical switch 80 includes a switch 82, a housing 84, and various different electrical components 86. The switch 82 and the housing 84 can be formed from the flame resistant polymer composition of the present disclosure.

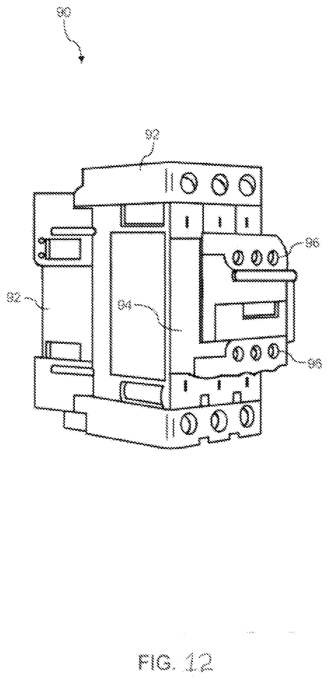

Referring to FIG. 12, another electrical component that can be constructed in accordance with the present disclosure is shown. More particularly, FIG. 12 illustrates an electrical contactor 90. The electrical contactor 90 includes a housing 92 that encloses a polymer component 94 that surrounds conductive components 96. The polymer or insulating component 94 and/or the housing 92 can be formed from the flame retardant polymer composition of the present disclosure.

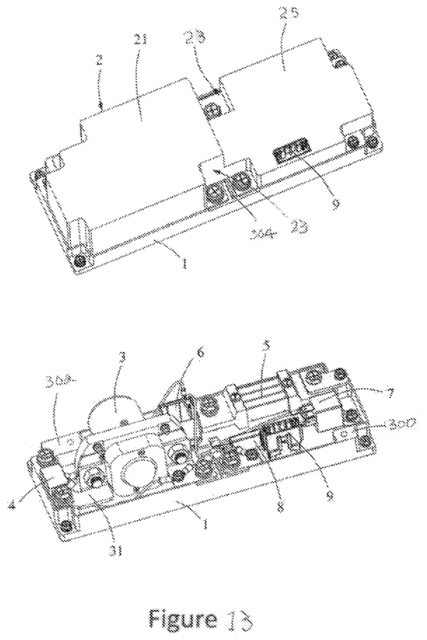

Apart from the structures shown in FIGS. 3 through 12, various other electric components, especially well suited for electric vehicles, may also employ the polymer composition of the present disclosure. In one embodiment, for example, a battery system of an electric vehicle may include a battery module (e.g., lithium ion battery module) that is electrically connected to a relay box. Typically, such boxes also include other electronic components, such as main relays, main fuses, shunts, heating relays, pre-charging relays, pre-charging resistors, etc. The polymer composition may be used to form one or more components of the battery module, relay box, or a combination thereof. In one embodiment, the relay box may contain a housing that includes the polymer composition. To realize charging and discharging of the battery module, the battery system may include a positive circuit, a negative circuit, a pre-charging circuit and a heating circuit composed of various electrical components. Referring to FIG. 13, for example, one embodiment of a battery system is shown that includes, for example, a main relay 3, main fuse 4, shunt 5, heating relay 6, pre-charging relay 7, and a pre-charging resistor 8. The system may also include a relay box that, in this particular embodiment, is formed from a housing that includes a base 1 and an upper cover 2. Of course, it should also be understood that the box may be an integral component, or may contain other portions. If desired, the base 1 and/or upper cover 2 may be made from the polymer composition of the present disclosure.

In the illustrated embodiment, the positive circuit includes the main relay 3 and the main fuse 4 connected in series. The main fuse 4 is electrically connected to the positive output terminal of the battery module (not shown). The upper cover 2 includes a first box cover 21 and a second box cover 25 that communicate with each other, the first box cover 21 covers a first area and the second box cover 25 covers a second area. The first box cover 21 and the second box cover 25 may be connected to form a stepped structure, so that the resulting box has a regular shape. The main fuse 4 may be connected in series with the main relay 3 through a connection row 31 to form a positive circuit, so that the input row of the positive circuit is fixedly supported on the first boss.

The outer side walls of the upper cover 2 have inwardly recessed grooves 23 at corner positions and the positions where the first box cover 21 and the second box cover 25 are connected. The grooves 23 in the upper left corner of the first box cover 21 give way to the input row of the positive circuit, and the grooves 23 in the upper left corner and the upper right corner of the second box cover 25 respectively give way to the input row and output row of the negative circuit. Further, the upper cover 2 and the base 1 are fixedly connected by bolts. Specifically, the diagonal positions of the accommodating groove have bosses 300 and bosses 302, and the diagonal positions of the upper cover 2 are recessed inward to form installation grooves. Preferably, a partition plate 304 is provided on the combination boss and located between the input row of the heating circuit and the output row of the positive circuit, so as to realize the physical insulation of the heating circuit and the positive circuit, and improve the reliability of the power distribution box. In addition, the box further includes an adapter plug 9. The positive circuit, the negative circuit, the heating circuit, and the pre-charging circuit are all connected to an external control unit through the adapter plug 9 for communication, which avoids the chaotic wiring inside the box and reduces the usage of the wiring harness.

The present disclosure may be better understood with reference to the following examples.

### EXAMPLE NO. 1

A long fiber-reinforced polymer composition was formulated in accordance with the present disclosure and tested for various properties. The formulation contained 52% by weight of nylon-6. The nylon-6 was heat stabilized. The nylon-6 was melt blended with two different compounded components. The first compounded component was added in an amount of 10% by weight and contained about 63% by weight aluminum diethylphosphinate, about 32% by weight melamine polyphosphate, and about 4.5% by weight zinc borate. The second compounded component was added in an amount of 8% by weight and contained 60% by weight melamine polyphosphate and 40% by weight of nylon-6. The composition also contained 30% by weight continuous glass fiber rovings (filament diameter of about 16 to 17 microns). The above separate components were melt blended together and formed into pellets. The fibers were about 11 mm in length. The polymer composition was tested for various properties and the following results were obtained:

| | Value | Unit | Test Standard |
|---|---|---|---|
| Physical Properties | | | |
| Density | 1450 | kg/m³ | ISO 1183 |
| Mechanical Properties | | | |
| Tensile modulus | 10543 | MPa | ISO 527-1, -2 |
| Tensile stress at break, | 144 | MPa | ISO 527-1, -2 |
| 5 mm/min | | | |
| Tensile strain at break, | 1.85 | % | ISO 527-1, -2 |
| 5 mm/min | | | |
| Flexural modulus, 23° C. | 9850 | MPa | ISO 178 |
| Flexural strength, 23° C. | 238 | MPa | ISO 178 |
| Charpy notched impact | 23.2 | kJ/m² | ISO 179/1eA |
| strength, 23° C. | | | |
| Thermal Properties | | | |
| Flammability @ 1.6 mm | V—O | class | UL 94 |
| nom. thickn. | | | |

### EXAMPLE NO. 2

Another polymer composition was made in accordance with the present disclosure and tested for various properties. In this example, the polymer composition contained 7.75% by weight nylon-6 as described in Example No. 1 and was combined with 31.75% by weight nylon-6,6.

The polymer composition contained the same two compounded components as described in Example No. 1. The first compounded component containing the metal phosphinate was present in an amount of 11.1% by weight. The second compounded component containing nylon-6 and melamine polyphosphate was added in an amount of 8.9% by weight. The same continuous glass fiber rovings were added in an amount of 40% by weight. In addition, 0.5% by weight of a lubricant, calcium stearate, was also added. The process of Example No. 1 was repeated and the following results were obtained:

| | Value | Unit | Test Standard |
|---|---|---|---|
| Mechanical Properties | | | |
| Tensile modulus | 14786 | MPa | ISO 527-1, -2 |
| Tensile stress at break, | 166 | MPa | ISO 527-1, -2 |
| 5 mm/min | | | |
| Tensile strain at break, | 1.44 | % | ISO 527-1, -2 |
| 5 mm/min | | | |
| Flexural modulus, 23° C. | 13000 | MPa | ISO 178 |
| Flexural strength, 23° C. | 268 | MPa | ISO 178 |
| Charpy notched impact | 27.1 | kJ/m² | ISO 179/1eA |
| strength, 23° C. | | | |
| Thermal Properties | | | |
| DTUL at 1.8 MPa | 251 | ° C. | ISO 75-1, -2 |
| Flammability @ 1.6 mm | V—O | class | UL 94 |
| nom. thickn. | | | |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A fiber-reinforced polymer composition comprising:
a polymer matrix comprising a thermoplastic polymer, the polymer matrix comprising from about 30 wt. % to about 90 wt. % of the polymer composition;
a plurality of long reinforcing fibers that are distributed within the polymer matrix, wherein the fibers comprise from about 10 wt. % to about 70 wt. % of the polymer composition; and
a flame retardant system comprising a metal phosphinate and one or more synergists comprising a polyphosphate, and wherein the weight ratio between the metal phosphinate and the one or more synergists is from about 0.8:1 to about 1:3.

2. The fiber-reinforced polymer composition as defined in claim 1, wherein the weight ratio between the metal phosphinate and the one or more synergists is from about 1:1 to about 1:2.

3. The fiber-reinforced polymer composition as defined in claim 1, wherein a first synergist comprising a polyphosphate is compounded with the metal phosphinate and a second synergist comprising a polyphosphate is compounded with a carrier polymer.

4. The fiber-reinforced polymer composition as defined in claim 1, wherein, at a thickness of 1.6 millimeters, the composition exhibits a V0 rating as determined in accordance with UL94, wherein the composition displays a comparative tracking index of 600 volts or more as determined in accordance with IEC 60112:2020, and wherein the polymer composition exhibits a Limiting Oxygen Index of about 28 or more as determined in accordance with ISO 4589:2017.

5. The fiber-reinforced polymer composition as defined in claim 1, wherein the fibers are spaced apart and aligned in a substantially similar direction.

6. The fiber-reinforced polymer composition as defined in claim 1, wherein the metal phosphinate has the general formula (I) and/or formula (II): 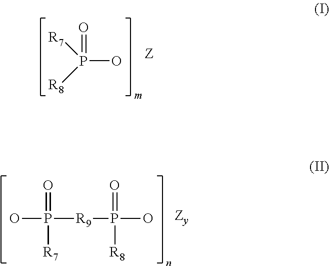
wherein,
R₇ and R₈ are, independently, hydrogen or substituted or unsubstituted, straight chain, branched, or cyclic hydrocarbon groups having 1 to 6 carbon atoms;
R₉ is a substituted or unsubstituted, straight chain, branched, or cyclic C₁-C₁₀ alkylene, arylene, arylalkylene, or alkylarylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4;
n is from 1 to 4; and
m is from 1 to 4.

7. The fiber-reinforced polymer composition as defined in claim 1, wherein the flame retardant system further comprises zinc borate.

8. The fiber-reinforced polymer composition as defined in claim 1, wherein the composition further comprises a lubricant.

9. The fiber-reinforced polymer composition as defined in claim 8, wherein the lubricant comprises calcium stearate.

10. The fiber-reinforced polymer composition as defined in claim 1, wherein the long reinforcing fibers have a fiber length of greater than about 6 mm, and less than about 40 mm.

11. An electrical connector that comprises opposing walls between which a passageway is defined for receiving a contact pin, wherein at least one of the walls contains the fiber-reinforced polymer composition as defined in claim 1.

12. A structural component of a battery comprising a side support, a cover, a separator, or a bottom support, comprising the polymer composition as defined in claim 1.

13. A fiber-reinforced polymer composition comprising:
a polymer matrix comprising a thermoplastic polymer, the polymer matrix comprising from about 30 wt. % to about 90 wt. % of the polymer composition;
a plurality of long reinforcing fibers that are distributed within the polymer matrix, wherein the fibers comprise from about 10 wt. % to about 70 wt. % of the polymer composition; and
a flame retardant system comprising a metal phosphinate and one or more synergists, the synergist comprising a metal salt of a phosphonic acid, a phosphonic acid, or mixtures thereof, the synergist being present in the composition in an amount greater than about 2% by weight.

14. The fiber-reinforced polymer composition as defined in claim 13, wherein the synergist is present in the composition in an amount less than about 5% by weight.

15. The fiber-reinforced polymer composition as defined in claim 13, wherein the synergist comprises a mixture of a metal salt of a phosphonic acid and a phosphonic acid.

16. The fiber-reinforced polymer composition as defined in claim 15, wherein the metal salt of the phosphonic acid is present in the composition in an amount from about 0.8% to about 1.8% by weight and the phosphonic acid is present in the composition in an amount from about 1.2% by weight to about 2.8% by weight.

17. The fiber-reinforced polymer composition as defined in 13, wherein the composition further comprises a metal salt of a carboxylic acid.

18. The fiber-reinforced polymer composition as defined in claim 17, wherein the metal salt of the carboxylic acid is present in the composition in an amount greater than about 0.2% by weight and in an amount less than about 3% by weight.

19. The fiber-reinforced polymer composition as defined in claim 17, wherein the metal salt of the carboxylic acid comprises calcium stearate, aluminum distearate, or mixtures thereof.

20. The fiber-reinforced polymer composition as defined in 13, wherein the metal phosphinate comprises aluminum diethyl phosphinate and is present in the composition in an amount greater than about 8% by weight, and in an amount less than about 18% by weight.
